(19) United States
(12) Patent Application Publication
(10) Pub. No.: US 2005/0284448 A1
(43) Pub. Date: Dec. 29, 2005

(54) Fuel pump system

(76) Inventors: John R. Forgue, Cheshire, CT (US); Matthias Henschel, Rheinmuenster (DE); Michael J. Riddell, Glastonbury, CT (US); Peter Schreuder, Kevelaer (DE)

Correspondence Address: William H. Francis;Reising, Ethington, Barnes, Kisselle, P.C., P. O. Box 4390, Troy, MI, 48090-4390, US

(21) Appl. No.: 11/153,150

(22) Filed: Jun. 15, 2005

Related U.S. Application Data
(60) Provisional application No. 60/582,216, filed on Jun. 23, 2004.

(51) Int. Cl. F02M 37/10

(52) U.S. Cl. 123/497

(57) ABSTRACT

A fuel pump system includes a fuel pump having a direct current motor for driving a pumping element to deliver fuel to an engine at a variable rate. A pulse width modulated controller is electrically communicated with the motor for varying the speed thereof, thereby enabling the fuel pump to deliver the fuel to the engine at the variable rate. The controller includes a first switch in series with the motor and a second switch in parallel across the motor. In a motor-off cycle, control electronics connected to the switches deactivate the first switch and activate the second switch to commutate the motor. In a motor-on cycle, the control electronics deactivate the second switch and activate the first switch to power the motor.

### REFERENCE TO RELATED APPLICATION

Applicants claim the benefit of U.S. provisional application, Ser. No. 60/582,216, filed Jun. 23, 2004.

### FIELD OF THE INVENTION

This invention relates generally to fuel systems for internal combustion engines, and more particularly to fuel pump systems having fuel pumps driven by electrically powered and electronically controlled direct current (DC) motors.

### BACKGROUND OF THE INVENTION

DC-motorized fuel pumps are widely used to deliver fuel from fuel tanks to internal combustion engines. Conventional methods of controlling fuel pressure and flow involve the use of a mechanical pressure regulator that ensures a constant supply of fuel at a fixed pressure to the engine and is typically mounted within or on the fuel tank in series with a fuel supply line to the engine. An outlet port of the fuel pump feeds the series combination of the regulator and the fuel supply line. The fuel pump motor is typically supplied with full battery voltage and any fuel flow in excess of engine demand is diverted back into the fuel tank via the mechanical pressure regulator. In other words, conventional fuel pumps always operate at full capacity even though fuel demand of the engine varies. Such fuel systems are relatively simple in that fuel pressure is regulated autonomously by a pump and the mechanical pressure regulator, without input from an electronic engine control module (ECM).

But more recently, fuel pump control strategies have grown in sophistication, and typically require input from an ECM, in order to support variable pressure and variable demand requirements; something that is not supported with the aforementioned conventional architecture. Typically, the ECM determines desired fuel pressure based on engine operating and load demand conditions. This pressure, and sometimes fuel demand and other information pertinent to controlling the fuel pump, are communicated to the fuel pump controller via electrical signals with suitable protocol. Accordingly, fuel pressure and quantity can be controlled more efficiently, without the use of a mechanical regulator, by supplying variable electrical power to the fuel pump in accordance to the engine demand for fuel. The amount of fuel delivered to the engine is varied by adjusting the speed of a pumping element by controlling the speed of the DC motor that drives the pumping element. By utilizing an electronic fuel pump controller that supports variable voltage and/or current to the fuel pump (that is, variable power), both variable pressure and variable demand can be achieved with no excess fuel delivery. This approach makes for a more efficient system in terms of minimizing power consumption, reduced fuel heating, less vapor generation, extended life of the pump, and quieter operation.

For example, pulse-width-modulated (PWM) controllers are used to control DC motors by modulating the amount of power delivered from a power supply to the DC motor by high frequency on/off switching of the connection therebetween. This action of on and off switching controls an average amount of power that is delivered to the DC motor, and the ratio of switch on-time to switch off-time is known as a duty cycle. Changing the duty cycle modifies the power delivered to the motor by providing change of the pump motor operating point and, thus, varies the fuel pressure and flow output to the engine.

In specific reference to the drawings, FIGS. 5 and 6 illustrate partial schematics of a prior art system including a DC fuel pump motor driven by a low-side power output stage of a PWM controller including control electronics, a power switch S1, a power control line between the control electronics and the power switch S1, and a recirculating diode. A positive terminal of the motor is connected to a voltage source +Vbattery and a negative terminal of the motor is operatively connected to a ground terminal by the PWM-controlled power switch S1 to complete the electrical path and deliver power to the motor. The recirculating diode is positioned across the motor with its cathode connected to both the voltage source and the positive terminal of the motor. The recirculating diode is necessary to provide a recirculation path for the release of energy stored in the inductance of the motor, and thereby preclude creation of damaging voltage transients.

Prior art FIG. 5 illustrates a conduction cycle (or motor-on cycle) wherein the PWM control electronics have momentarily closed the power switch S1 to permit power to flow from the battery or voltage source, through the motor, and to the ground terminal through the now-closed power switch S1. In this cycle, the recirculating diode does not conduct and, thus, does not recirculate power because it is reverse-biased wherein the cathode is at battery potential and the anode is at ground potential, neglecting switch drops.

In the recirculating cycle (or motor-off cycle) of FIG. 6, the PWM control electronics momentarily open the power switch S1 to interrupt the circuit and de-power the motor. Now, the recirculating diode commutates the inductive current in the motor from the negative motor terminal back to the positive motor terminal. Unfortunately, however, the recirculating diode is not 100% efficient and power is wasted through the diode as heat loss. For example, diodes in conventional fuel pump systems may have a forward voltage drop in excess of 0.8 volts.

To illustrate the problem, the power in the diode can be expressed with the following equation, assuming continuous recirculation of current:
P_{d}t_{off}*Iₘₒₜₒᵣ*V_{d}/(tₒₙ+t_{off})
where P_{d}=diode power dissipation
t_{off}=off time of drive stage
tₒₙ=on time of drive stage
V_{d}=diode forward voltage drop
Iₘₒₜₒᵣ=recirculating motor current
Thus, if a motor draws 10 amps, and a PWM controller has a 50% duty cycle at a switching frequency of 50 microseconds (μs) and a diode with a forward voltage drop of 0.8 volts, then

$${P}_{d} = 25 μs * 10 amps * 0.8 volts / ( 25 μs + 25 μs ) = 4.0 watts$$

Accordingly, system efficiency is compromised as energy is lost as heat. For a 100 watt power input, the diode yields a 4% efficiency drop, in addition to the unwanted heat this diode generates. In any case, the heat loss must be dissipated with a heatsink, which increases the controller package size and costs.

Despite significant improvements in the design and construction of DC-motorized fuel pump systems, there remains much room for reduction in electromagnetic interference properties and, thus, improvement in electromagnetic compatibility (EMC) performance of these systems, and reduction in size of controller packages therefor. In the utilization of PWM drives, fast rise and fall times are known to contribute excessively to electromagnetically-radiated emissions. Compounding this problem is the use of long cable runs (typically in excess of 0.5 meters) for a controller-to-pump cable run. Current fuel pump systems also use PWM controllers that tend to run hot due to significant power conversion inefficiencies, thereby requiring relatively large heatsinks with heatsink fins and, thus, larger electronics packages.

### SUMMARY

There is provided a fuel pump system for delivering fuel from a fuel tank to an internal combustion engine. A fuel pump has at least one of a dynamic pumping element or a positive displacement pumping element for pumping the fuel. A direct current motor is provided for driving the dynamic pumping element or the positive displacement pumping element to deliver the fuel to the engine at a variable rate. A pulse width modulated controller is provided in electrical communication with the direct current motor for varying the speed of the direct current motor, thereby enabling the fuel pump to deliver the fuel to the engine at the variable rate. The controller includes a first switch that is arranged in series with the direct current motor and that has its controlling element connected to a power control line. A second switch is arranged in parallel across the direct current motor and has its controlling element connected to a recirculation control line. Control electronics are connected to the power control line for generating a power-off control signal to deactivate the first switch to off in a motor-off cycle, and also for generating a power-on control signal to activate the first switch to on in a motor-on cycle for powering the direct current motor. The control electronics are also connected to the recirculation control line for generating a recirculation-on control signal to activate the second switch to on in the motor-off cycle to commutate the direct current motor, and also for generating a recirculation-off control signal to deactivate the second switch to off in the motor-on cycle.

At least some of the objects, features and advantages that may be achieved by at least certain embodiments of the invention include providing a fuel pump system that is readily adaptable to various fuel system applications; that allows for improvements in EMC performance; permits reduction in the size of a control electronics package; yields less heat loss and an increase in operating efficiency; is of relatively simple design and economical manufacture and assembly, is reliable and has a long, useful service life.

Of course, other objects, features and advantages will be apparent in view of this disclosure to those skilled in the art. Various other fuel systems and fuel pump systems embodying the invention may achieve more or less than the noted objects, features or advantages.

### BRIEF DESCRIPTION OF THE DRAWINGS

These and other objects, features and advantages of the present invention will be apparent from the following detailed description of the preferred embodiment(s) and best mode, appended claims, and accompanying drawings in which:

FIG. 1A is a diagrammatic view of a fuel system incorporating a fuel pump system according to an embodiment of the present invention;

FIG. 1B is a diagrammatic view of an alternative fuel system;

FIG. 1C is a diagrammatic view of another alternative fuel system;

FIG. 2 is a topological schematic of a portion of the fuel pump system of FIG. 1A, illustrating a DC-motorized fuel pump and associated low-side controller and switches that depict a motor-on cycle;

FIG. 3 is a modified version of the schematic of FIG. 2, illustrating a motor-off cycle;

FIG. 4 is a topological schematic of an alternative portion the fuel pump system of FIG. 1A, illustrating a DC-motorized fuel pump and associated high-side controller and switches that depict a motor-off cycle;

FIG. 5 is a topological schematic of a traditional DC-motorized fuel pump and associated low-side controller that illustrates a motor-on cycle, according to the prior art; and

FIG. 6 is a modified version of the schematic of FIG. 5, illustrating a motor-off cycle for a traditional drive configuration.

### DETAILED DESCRIPTION

In general, the present invention yields improvements in performance of electromagnetic compatibility (EMC) and reduction in size of electronics packages for PWM-controlled DC-motorized fuel pumps. EMC is the ability of electronic equipment to function satisfactorily without generating intolerable electromagnetic disturbance to other nearby electronics. One way to improve EMC performance is to add electrical components such as electromagnetic filters, decoupling capacitors, and the like. But this type of improvement tends to increase packaging size and cost instead of reduce it.

Therefore, using the present invention, EMC performance is improved by slowing the PWM switching times to promote lowering the rate change of voltage, dv/dt, and rate change of current, di/dt. Both of these measures serve to lower or limit harmonic content in the transmission line. In high performance PWM drives, it is possible to achieve switching times in the tens of nanoseconds. While this promotes increased efficiency, such switching times would be prohibitive in the implementation of a remote fuel pump with controller-to-pump cables that tend to act as transmission lines, thereby giving rise to elevated electromagnetically-radiated emissions. Automotive guidelines generally specify an acceptable rate change of voltage (dv/dt) as less than one V/μs and rate changes of current (di/dt) as less than 300 milli-Amps/μs. This equates to a switching time of greater than 12 μs for a 12V system. While this is generally prohibitively high, it is desired to slow the switching time in order to meet EMC requirements.

But slower switching tends to generate waste heat that, in addition to other waste heat generated by the PWM, must be dissipated by increasing, rather than reducing, packaging size to accommodate a larger heat sink for dissipating the waste heat attributable to the slower switching. Thus, improvements in EMC performance and reductions in PWM packaging size were found to be competing goals.

In developing the present invention to address these goals, it was discovered that reductions in packaging size and improvements in EMC performance could both be obtained if a substantial portion of the other waste heat generated by the PWM could be dissipated by some other means or if the other waste heat could be substantially precluded. As to the latter, the other waste heat in prior art PWM controllers was found to be substantially generated by a single type of component—a recirculating diode across the motor.

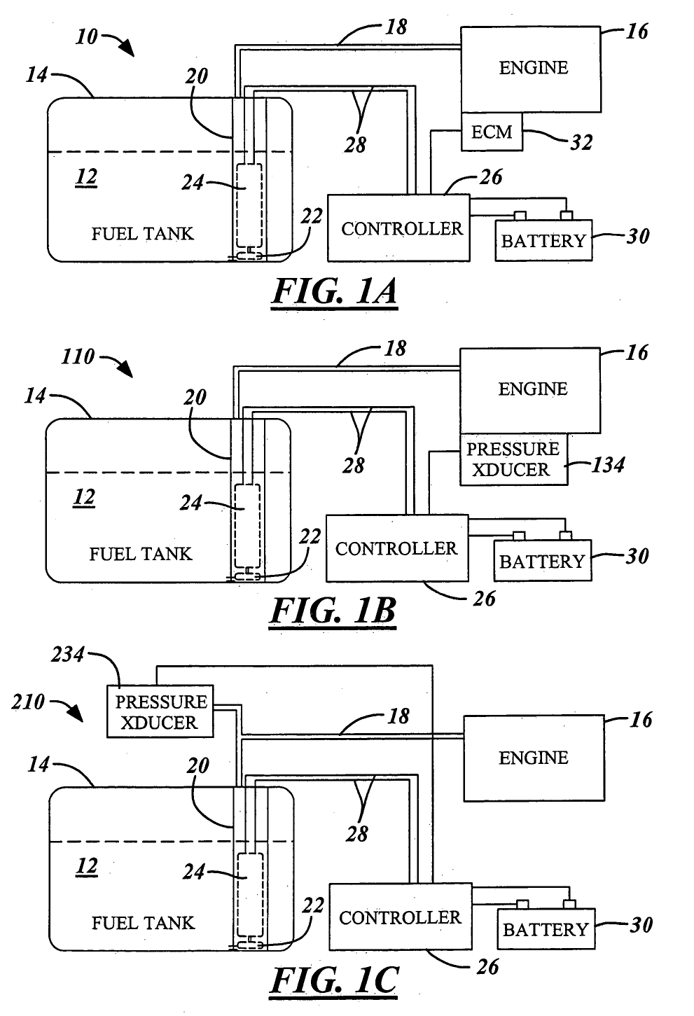

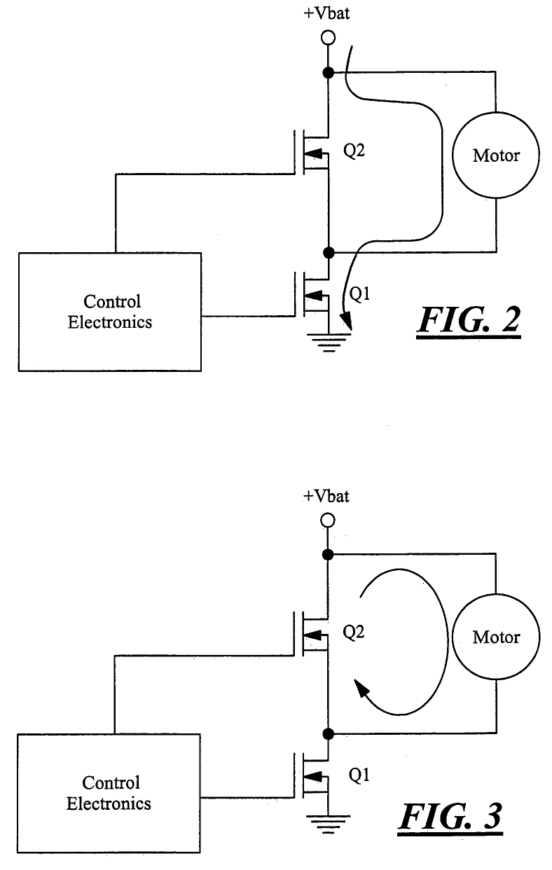

FIG. 1A illustrates a fuel system 10 that incorporates the features of the present invention and provides fuel 12 from a fuel tank 14 to an internal combustion engine 16. The fuel 12 is discharged from the fuel tank 14 through a main fuel supply line 18 by a fuel pump 20 positioned within the fuel tank 14. The fuel pump 20 includes a dynamic pumping element 22 such as a turbine, or positive displacement element like a gerotor, or the like, that pumps fuel and is driven by a DC electric motor 24, which is coupled thereto. A remotely located PWM controller 26 is connected to the motor by extended control lines 28 and the controller 26 is supplied with power from a voltage source such as a battery 30. Alternatively, the present invention contemplates use of an electronic engine control module (ECM) 32 that may communicate with the fuel pump controller 26 using well known electrical signals and suitable protocol such as analog, digital, PWM, or controller area network (CAN). The ECM 32, among other functions, determines desired fuel pressure based on engine load demand conditions and other operating conditions and communicates such control input information to the fuel pump controller 26. Alternatively, however, the fuel pump controller 26 may be operated independently of the ECM 32, such that it does not require any communication of pump control input information therefrom. The fuel pump 20, motor 24, and controller 26 comprise a fuel system that operates in accordance with the principles of the present invention described with reference to FIGS. 2 through 4.

FIGS. 1B and 1C illustrate other presently preferred embodiments of fuel systems 110, 210. These embodiments are similar in many respects to the embodiment of FIG. 1A and like numerals between the embodiments generally designate like or corresponding elements throughout the several views of the drawing figures. Additionally, the description of the common subject matter may generally not be repeated here.

In FIG. 1B, the fuel system 110 includes a fuel pressure transducer 134 for measuring the pressure of fuel in the engine 16 at any given moment. The transducer 134 is preferably in electrical communication with the fuel pump controller 26 and in fluid communication with a fuel injector line, fuel rail or the like, within the engine 16. Accordingly, the controller 26 may be operated based on actual fuel pressure at the engine 16.

In FIG. 1C, the fuel system 210 includes a fuel pressure transducer 234 for measuring the pressure of fuel supply output at any given moment. The transducer 234 is preferably in electrical communication with the fuel pump controller 26 and in fluid communication with main fuel supply line 18 just downstream from the fuel pump 20. Accordingly, the controller 26 may be operated based on actual fuel pressure at the engine 16.

In developing the present invention, it was discovered that the relatively inefficient and hot-running diode could be replaced with a more efficient and cooler-running electronic switch. Such a switch is preferably a semiconductor switch such as, but not limited to, a metal oxide semiconductor field effect transistor (MOSFET), bipolar junction transistor (BJT), insulated gate bipolar transistor (IGBT), silicon controlled rectifier (SCR), thyristor, other controlled rectifiers, and the like. In any case, the switch replaces the diode and operates in accordance with general principles of synchronous rectification. Conventionally, a synchronous rectifier is a device in which contacts thereof are opened and closed at correct instants of time for rectification by a synchronous vibrator, or the like. For example, in the field of switch-mode power supplies, a “steering” diode is replaced or paralleled with a transistor to reduce losses and thereby increase efficiency, wherein the transistor is turned off during an inductor charge cycle and then turned on as the inductor discharges into the load. Here, however, a MOSFET operates as a recirculating device for a motor in which contacts of the MOSFET are gated at correct instants of time for commutating the inductive energy of the motor.

FIGS. 2 and 3 illustrate partial schematics of a system according to one embodiment of the present invention, including a DC fuel pump motor driven by a low-side power output stage of a PWM controller, which includes control electronics, a power switch Q1 such as a MOSFET, BJT, IGBT, thyristor, SCR, and the like, a synchronous rectifier or recirculating switch Q2 such as a MOSFET, BJT, IGBT, thyristor, SCR, and the like, and control lines between the control electronics and the switches Q1, Q2. A positive terminal of the motor is connected to a voltage source +Vbat and a negative terminal of the motor is operatively connected to a ground terminal by the PWM-controlled power switch to complete the electrical path and deliver power to the motor. The power switch Q1 is positioned in series with the motor, with its source connected to ground, its drain connected to the negative motor terminal, and its controlling element or gate connected to the PWM control electronics via the power control line. The second, recirculating switch Q2 is positioned across the motor with its drain connected to both the voltage source and the positive terminal of the motor, its source connected to both the drain of the power switch Q1 and the negative terminal of the motor, and its gate connected to the PWM control electronics via the recirculation control line. The recirculating switch Q2 is necessary for recirculating current through the motor to commutate the inductive energy resident therein and thereby preclude creation of damaging voltage transients.

FIG. 2 illustrates a conduction cycle (or motor-on cycle) wherein the PWM control electronics have momentarily turned on or closed the power switch Q1 “on” by sending a power-on signal through the power control line to engage or activate the switch gate to permit power to flow from the battery or power supply, through the motor, and to the ground terminal through the closed power switch Q1. Simultaneously, or just prior to the activation of power switch Q1 with appropriate deadtime, the PWM control electronics have momentarily turned off or opened the recirculating switch Q2 “off” by sending a recirculation-off signal through the recirculation control line to disengage or deactivate the switch gate such that the recirculating switch does not conduct and, thus, does not short out the motor. In other words, the MOSFETS are synchronized with one another such that both cannot be closed at the same time, thereby avoiding shorting the battery thereacross and damaging the MOSFETS.

In a recirculating cycle (or motor-off cycle) of FIG. 3, the PWM control electronics momentarily open the power switch Q1 off by sending a power-off signal along the power control line to deactivate the switch gate and thereby interrupt the circuit and remove applied power to the motor. After a short duration, or deadtime, the PWM control electronics close the recirculating switch Q2 on by sending a recirculation-on signal through the recirculation control line to activate the switch gate such that the recirculating switch Q2 conducts and, thus, commutates the inductive energy in the motor from the negative motor terminal back to the positive motor terminal.

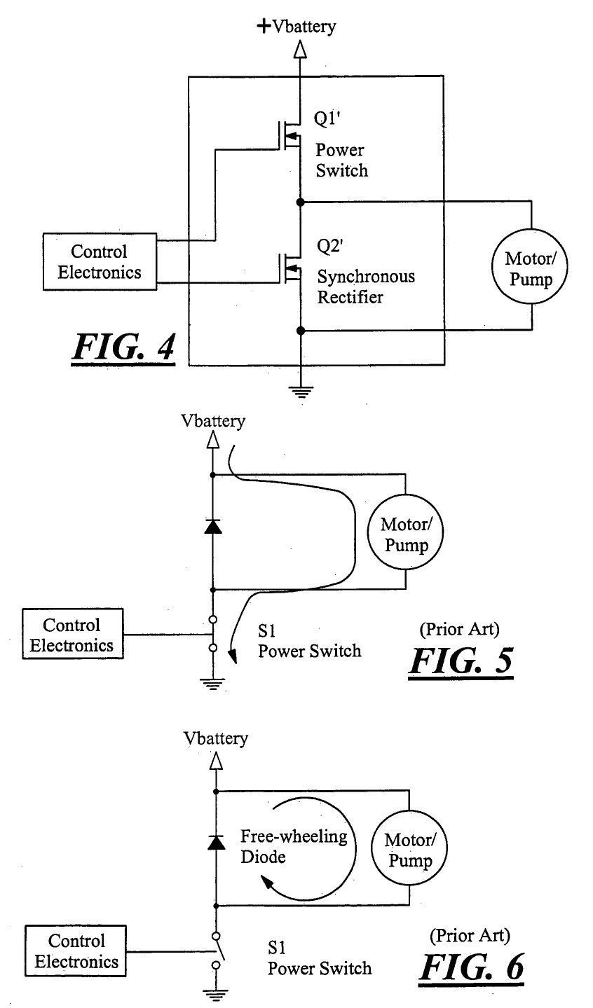

FIG. 4 illustrates a partial schematic of a system according to another embodiment of the present invention, including a DC fuel pump motor driven by a high-side power output stage of a PWM controller, which includes control electronics, a power switch Q1′ such as a MOSFET, BJT, IGBT, thyristor, SCR, and the like, a synchronous rectifier or recirculating switch Q2′ such as a MOSFET, BJT, IGBT, thyristor, SCR, and the like, and control lines between the control electronics and the switches Q1′, Q2′. A positive terminal of the motor is operatively connected to a voltage source +Vbattery by the PWM-controlled power switch Q1′ and a negative terminal of the motor is connected to a ground terminal to complete the electrical path and deliver power to the motor. The power switch Q1′ is positioned in series with the motor, with its drain connected to the voltage source +Vbattery, its source connected to the positive motor terminal, and its controlling element or gate connected to the PWM control electronics via the power control line. The second, recirculating switch Q2′ is positioned across the motor with its drain connected to both the source of the power switch Q1′ and the positive terminal of the motor, its source connected to both the ground and the negative terminal of the motor, and its gate connected to the PWM control electronics via the recirculation control line. The recirculating switch Q2′ is necessary for recirculating current through the motor to commutate the inductive energy resident therein and thereby preclude creation of damaging voltage transients.

In a recirculating cycle (or motor-off cycle) of FIG. 4, the PWM control electronics momentarily open the power switch Q1′ off by sending a power-off signal along the power control line to deactivate the switch gate and thereby interrupt the circuit and remove applied power to the motor. After a predetermined amount of deadtime, the PWM control electronics close the recirculating switch Q2′ on by sending a recirculation-on signal through the recirculation control line to activate the switch gate such that the recirculating switch Q2′ conducts and, thus, commutates the inductive energy in the motor from the negative motor terminal back to the positive motor terminal.

The circuit of FIG. 4 also operates in a conduction cycle (or motor-on cycle) wherein the PWM control electronics momentarily close the power switch Q1′ on by sending a power-on signal through the power control line to activate the switch gate to permit power to flow from the battery or power supply, through the motor, and to the ground terminal. Simultaneously, or just prior to the activation of the power switch Q1′ with appropriate dead time, the PWM control electronics momentarily open the recirculating switch Q2′ off by sending a recirculation-off signal through the recirculation control line to deactivate the switch gate such that the recirculating switch does not conduct and, thus, does not short out the motor. In other words, the MOSFETS Q1′, Q2′ are synchronized with one another such that both cannot be closed at the same time, thereby avoiding shorting the battery thereacross and damaging the MOSFETS Q1′, Q2′.

The high side configuration is preferred to yield even higher EMC performance than the low side configuration. In both the low and high side configurations, the negative lead of the motor is connected to ground on a respective circuit board and to an electrically conducting meal can or housing of the fuel pump. In the low-side configuration of FIGS. 2 and 3, the negative terminal of the motor floats between ground during the conduction cycle and the voltage source during the recirculating cycle. The cyclical change in potential tends to adversely affect EMC performance. In the high side configuration, however, the negative lead of the motor is continuously—not cyclically—connected to ground. Therefore, in the high side configuration, the fuel pump housing is suspended in space but has a continuously grounded potential, thereby improving EMC performance.

Advantageously, and compared to the recirculating diode of the prior art, the recirculating switches Q2/Q2′ are more efficient and less power is wasted therethrough as heat loss. MOSFET losses are characterized by DC drain-source resistance losses (i.e. I²R losses) and switching losses. In considering either topology it is assumed that the switching times, and thus the switching losses, are made similar for comparable dv/dt and EMC performance and, hence, are not included in the following power dissipation calculation of the recirculating MOSFET:
Pₛᵣ=(Iₘₒₜₒᵣ)²*R_{DS(on)}*t_{off}/(tₒₙ+t_{off})
where
Pₛᵣ=power dissipation of synchronous rectifier MOSFET
Iₘₒₜₒᵣ=recirculating motor current
R_{DS(on)}=MOSFET drain-source resistance
t_{off}=off time of drive stage
tₒₙ=on time of drive stage
Thus, if a motor draws 10 amps, a typical drain-source resistance is 0.01 ohms, and a PWM controller has a 50% duty cycle at a switching frequency of 50 μs, then

$${P}_{sr} = {( 10 amps )}^{2} * 0.01 ohms * 25 μs / ( 25 μs + 25 μs ) = 0.5 watts$$

Compared to the recirculating diode topology, here, system efficiency is superior and less energy is lost as heat. For a 100 watt power input, the MOSFET yields only a 0.5% efficiency drop. This translates into a nearly ten-fold reduction in DC power dissipation over the prior art, thereby providing opportunity to slow switching speeds of the MOSFETS for improved EMC performance.

A major benefit of the synchronous rectification design of the present invention is the ability to make improvements in EMC through switching speed reduction while maintaining a manageable thermal dissipation level without substantial heatsinking requirements. In relatively low and medium power-draw fuel pumps, little to no heatsinking may be required. In some cases, potting compound used to seal an internal volume of the pump electronics package from water infiltration will provide enough heat spreading to preclude use of heatsinking. But relatively higher power-consuming pump applications such as those in the 80 to 100 watt range or more may require some minimal heatsinking. In any case, the present synchronous rectification design eliminates the need to provide heatsink fins to cool the controller, thereby enabling a smaller controller package. Synchronous rectification according to the present invention mitigates or eliminates the need for heatsinking and thereby yields packaging that can be designed to occupy a smaller volume thereby decreasing overall product cost.

In conclusion, the present invention provides many advantages. First, EMC performance is improved because PWM-MOSFET switching speed can be decreased to a few tens of volts per microsecond or less, which represents more than a ten-fold improvement over conventional hard-switched designs. Second, increases in MOSFET heat dissipation, due to decreases in switching speed, are relatively negligible and can be easily absorbed by minimal heatsinking. Eliminating the recirculating diode and attendant high heat dissipation of the prior art further enables elimination of a heat sink and/or reductions in volume of potting compound and packaging size, thereby decreasing weight and costs. Third, with the present invention yielding a smaller electronics package, more options are available to locate the package in smaller spaces of a vehicle, such as within a housing of a combined motor/pump unit for certain pump applications. Finally, a more efficient system is provided because relatively more energy is recirculated back to the motor and output as mechanical energy instead of being wasted as heat. In other words, the present invention provides a DC-motorized fuel pump system that is smaller, more efficient, more electromagnetically compatible, and less expensive than prior art designs.

While the forms of the invention herein disclosed constitute a presently preferred embodiment, many others are possible. It is not intended herein to mention all the possible equivalent forms or ramifications of the invention. It is understood that terms used herein are merely descriptive, rather than limiting, and that various changes may be made without departing from the spirit and scope of the invention as defined by the following claims.

1. A controller electrically communicated with a motor of a fuel pump to vary the speed thereof and thereby enable the fuel pump to deliver fuel to an engine at a variable rate, comprising:
a first switch in series with the motor and having a controlling element;
a second switch in parallel across the motor and having a controlling element; and
control electronics connected to the controlling elements of the first and second switches, and operable in a motor-off cycle to deactivate the first switch to turn the motor off and to activate the second switch to commutate the motor, and being further operable in a motor-on cycle to deactivate the second switch and to activate the first switch to turn the motor on.

2. A fuel pump system for delivering fuel from a fuel tank to an internal combustion engine, comprising:
a fuel pump having at least one of a dynamic pumping element or a positive displacement pumping element for pumping the fuel;
a direct current motor for driving the at least one of the dynamic pumping element or the positive displacement pumping element to deliver the fuel to the engine at a variable rate;
a pulse width modulated controller in electrical communication with the direct current motor for varying the speed of the direct current motor, thereby enabling the fuel pump to deliver the fuel to the engine at the variable rate, the controller including:
a first switch arranged in series with the direct current motor and having its controlling element connected to a power control line;
a second switch arranged in parallel across the direct current motor and having its controlling element connected to a recirculation control line; and
control electronics connected to the power control line for generating a power-off control signal to switch the first switch to off in a motor-off cycle, and also for generating a power on control signal to switch the first switch to on in a motor-on cycle for powering the direct current motor, the control electronics also connected to the recirculation control line for generating a recirculation on control signal to switch the second switch to on in the motor-off cycle to commutate the direct current motor, and also for generating a recirculation off control signal to switch the second switch to off in the motor-on cycle.

3. The fuel pump system of claim 2 wherein the controller is in communication with an electronic engine control module for obtaining control input information.

4. The fuel pump system of claim 2 wherein the controller is not in communication with an electronic control module.

5. The fuel pump system of claim 2 wherein said first switch is positioned on a high-side of said direct current motor.

6. The fuel pump system of claim 2 wherein said first switch is positioned on a low-side of said direct current motor.

7. The fuel pump system of claim 2 wherein the controller is in electrical communication with a fuel pressure transducer.

8. The fuel pump system of claim 7 wherein the fuel pressure transducer is in fluid communication with the fuel pump.

9. The fuel pump system of claim 7 wherein the fuel pressure transducer is in fluid communication with a portion of the engine.

10. The fuel pump system of claim 2 wherein heatsink fins are not required to cool the controller.

11. A method of controlling operation of a motor of a fuel pump to vary the speed thereof and thereby enable the fuel pump to deliver fuel to an engine at a variable rate, comprising:
providing a first switch in series with the motor;
providing a second switch in parallel across the motor;
in a motor-off cycle, deactivating the first switch to turn the motor off and activating the second switch to commutate the motor; and
in a motor-on cycle, deactivating the second switch and activating the first switch to turn the motor on.
